(19) United States
(12) Patent Application Publication
(10) Pub. No.: US 2008/0228520 A1
(43) Pub. Date: Sep. 18, 2008

(54) Body Management System and Business Method

(76) Inventors: Scott Day, Dallas, TX (US); Pascal Servell, Dallas, TX (US)

Correspondence Address: CARSTENS & CAHOON, LLP, P O BOX 802334, DALLAS, TX, 75380, US

(21) Appl. No.: 11/685,658

(22) Filed: Mar. 13, 2007

(51) Int. Cl. G06Q 50/00

(52) U.S. Cl. 705/2

(57) ABSTRACT

A system and business method for maintaining the health and body fitness of a client patient. The system and method are conducted by a Registered Dietitian (RD), and a technician (nurse). The RD conducts an ongoing assessment of the client to evaluate the client's progress in attaining his or her goals, as well as providing nutritional education and lifestyle modification training to ensure long-term success of the treatment. The technician conducts any tests required during the RD assessments and supervises client performance of the treatment. Various technologies are utilized to help the client achieve his or her body shaping and fitness goals.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to Individual health management systems and more specifically to an overall system and business method for promoting weight loss and body shaping in an individual.

2. Description of Related Art Including Information Disclosed Under 37 CFR 1.97 and 1.98

Obesity in the United States is a serious problem. According to the National Health and Nutrition Examination Survey for 1999-2002, over 30% of U.S. adults aged 20 and older are obese with a body mass index (BMI) of 30 or over. In addition, 65% of U.S. adults aged 20 and older are either overweight or obese with a BMI of 25 or over. Contributing to the prevalence of this obesity is the sedentary lifestyle and unhealthy diet experienced by most.

Obesity causes serious health complications such as hypertension; dyslipidemia; type 2 diabetes; heart disease; stroke; gallbladder disease; osteoarthritis; sleep apnea and other respiratory problems; and cancers such as endometrial, breast, and colon. According to the Surgeon General, these health complications resulted in health care expenditures in excess of $117 billion in 2000.

Given the seriousness of the issue, a variety of proposals have been made in an effort to combat obesity. Weight loss programs (such as Jenny Craig, Weight Watchers, Atkins Diet, South Beach diet, etc.) have been developed in response. These weight loss programs often do help some patients to lower their BMI. However, they can be complicated to follow, expensive to implement, and difficult to fit a person's lifestyle. In addition, these diets tend to be short term solutions and do nothing to teach long term habits of real food choices. Dieters often see weight loss early in dieting, stop the diet, and then regain the weight which causes them to restart the diet cycle (“yo-yo” dieting). Also, these diets are often unhealthy given their low calorie mandates and un-balanced food choices which leads to other health risks.

Surgery has also been recommended as another solution to the obesity issue. For instance, some patients undergo liposuction to remove fat or gastric bypass procedures to reduce their caloric intake. These procedures are costly and often lead to complications such as infections that can further damage the patient's health. Also, these procedures do not address the long term lifestyle changes necessary to properly maintain the patient's health.

Herbal remedies are another method recommended and used by some to manage their obesity. Weight loss pills, drinks, and other substances are marketed and consumed freely. Thus far no scientific evidence has shown these substances to be effective for this purpose. Also, the FDA has yet to approve of their use for obesity management. Consumption of unverified and unapproved substances can cause additional health complications above and beyond that dealing with weight. Also, herbal remedies tend to be costly and do nothing to promote the lifestyle changes necessary to properly address this health issue.

Self-guided exercise and diet books are a lower-cost solution that also tends to be a short-term fix to the obesity problem. By purchasing a diet book or a health club membership, it is up to the patient to properly motivate his or her self to follow the regimen. If the patient possessed the necessary motivation to make this a success, they likely would not be in this situation to begin with. Most patients are motivated at first and tend to slip back into their original sedentary lifestyle with poor nutrition habits. Self-guided remedies lack accountability and require more motivation than most patients are capable of.

Accordingly, a need exists for a body management system and method that provides short term results through proper nutrition and exercise as well as long-term behavior modification through education and training. Further, a need exists for a system and method that is relatively simple to access and utilize, and is flexible to fit any patient's lifestyle. Further still, a need exists for a system and method that is safe and effective to use and that provides a motivational atmosphere to encourage active participation. The present invention meets these needs and others as will be demonstrated in the following disclosure.

### BRIEF SUMMARY OF THE INVENTION

The present invention overcomes many of the disadvantages of the prior art by combining nutrition, education, and technology into a single unit. This unit is accessible by any individual, regardless of the individual's lifestyle, and features elements that encourage and achieve short and long-term lifestyle changes that improve the individual's overall health and appearance. While the present invention primarily focuses on the treatment of female clients, many of the teachings can be applied to male clients as well.

The present invention provides at least one physician (MD), Registered Dietitian (RD), and technician (possibly a nurse) to assess, educate, and supervise the patient's progress in attaining their body shaping goals. The MD monitors the progress achieved by the patient and provides direction to the RD and the Technician as required. The RD conducts an initial overall assessment of the patient; performs a nutrition evaluation; develops a meal plan; monitors the patient's progress; and follows-up with the patient on a regular basis even after the patient has achieved his or her desired goals. The technician monitors the patient's usage of the technology (equipment), administers tests and assists the MD and RD in performance of their roles.

A nutritional evaluation is conducted for the patient by the RD. Results of the evaluation are used to:
Provide the patient with their “Perfect Point” and their “Current Point”. Each point is the result of a calculation that takes into account the patient's fat percentage, the total daily calorific expenditure of the patient (RMR, exercise, daily activity and FP technology component) and the daily caloric intake of the patient as determined by the RD. Other values may be imputed depending on the shape of the patient such as, but not limited to, waist to hips ratio, waist to height ratio and waist circumference. The “Perfect Point” is intended to give the patient clear visibility as to his/her progression towards his/her goal.

Determine the patient's nutritional needs and the type of treatment plan. A nutrition meal plan teaches the patient how to eat nutritionally sound meals for the rest of his or her life. Each plan is custom tailored to the patient, and includes instruction on reading food labels and determining portion size. Supplements are recommended and provided as necessary to compensate for any deficiencies.

Education is provided primarily by the RD. The RD consults with the patient, discussing nutrition and exercise. The RD recommends meal choices and educates the patient on food selection, portion sizes, and overall quantities. The technician recommends exercise plans and educates the patient on use of technology in the exercise regimen. The MD may consult with the patient regarding how best to deal with any health issues or concerns during dieting and exercising.

Technology is provided to assist the patient in attaining his or her fitness and body shaping goals. Numerous devices are incorporated, such as a bio-electrical impedance analysis (BIA) device to assist in the assessment of the patient by providing body fat percentage, hydration level, metabolic rate, and body mass index (BMI). A recumbent stationary bike is provided to encourage cardiovascular fitness and help increase metabolism. A vibration platform is provided to conduct whole body vibration training to increase the percentage of muscle fibers that are exercised as well as to mobilize fat in the blood stream. A hyperthermia inducing device is provided to increase the patient's metabolism by promoting increased cellular activity and blood flow, and to loose weight and detoxify the patient through sebaceous gland sudation. A dermatological shockwave therapy device is provided to reduce fat by mobilizing fat in the bloodstream. Mesotherapy, electrotherapy, and ultrasound are provided to reduce fat through emulsification. Further, a medical photography station regularly captures images of the patient's progress during all phases of treatment.

The present invention seeks to provide a body management system and method that includes weight loss and body shaping; decrease the level of heavy metals and other toxins in the client's body; and increase the client's bone density while finning and toning the client's skin and reducing the amount of cellulite. Further objects, features, and advantages of the present invention will become apparent in light of the following detailed description.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, in which like reference numbers refer to like parts throughout the views, wherein:

FIG. 1 is a diagram depicting the interrelation of the members of an embodiment of the present invention with the client patient utilizing the embodiment.

FIG. 2 is a graphic depicting the three basic components of the embodiment of the present invention;

FIG. 3 is a flow diagram of the process followed in the embodiment of the present invention as it is applied to a client patient;

FIG. 4 is a graphic depicting detail of the role performed by the RD in the embodiment of the present invention;

FIG. 5 is a sample of a typical Nutrition Evaluation performed by an RD for a client patient in the embodiment of the present invention;

FIG. 6 is a table illustrating a treatment table for Group 1 client patients utilizing the present embodiment;

FIG. 7 is a table illustrating a treatment table for Group 2 client patients utilizing the present embodiment;

FIG. 8 is a table illustrating a treatment table for Group 3 client patients utilizing the present embodiment;

FIG. 9 is a diagram depicting how fat is burned with the present embodiment along with the respective treatments;

FIG. 10 is an image of a hyperthermia treatment apparatus as used in the present embodiment;

FIG. 11 is an image of a dermatological shock wave therapy apparatus as used in the present embodiment, highlighting the two different applicators, as is used for treatment of fat through mobilization into the bloodstream;

FIG. 12 is an image of a whole body vibration platform as used in the present embodiment, with images of various exercises that can be performed on the platform;

FIG. 13 is an image of a combination electrotherapy/ultrasound device as used in the present embodiment for treatment of fat through emulsification;

FIG. 14 is an image of a bio-electrical impedance analysis (BIA) device as used in the present embodiment to measure individual client properties related to body fat percentage, hydration level, metabolic rate, and BMI;

FIG. 15 is a floor layout of an embodiment of the system of the present invention as used in performing the method of the present invention, with the system element placement highlighted for optimum efficiency; and

FIG. 16 is a table illustrating a treatment table for Group 4 client patients utilizing the present embodiment.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

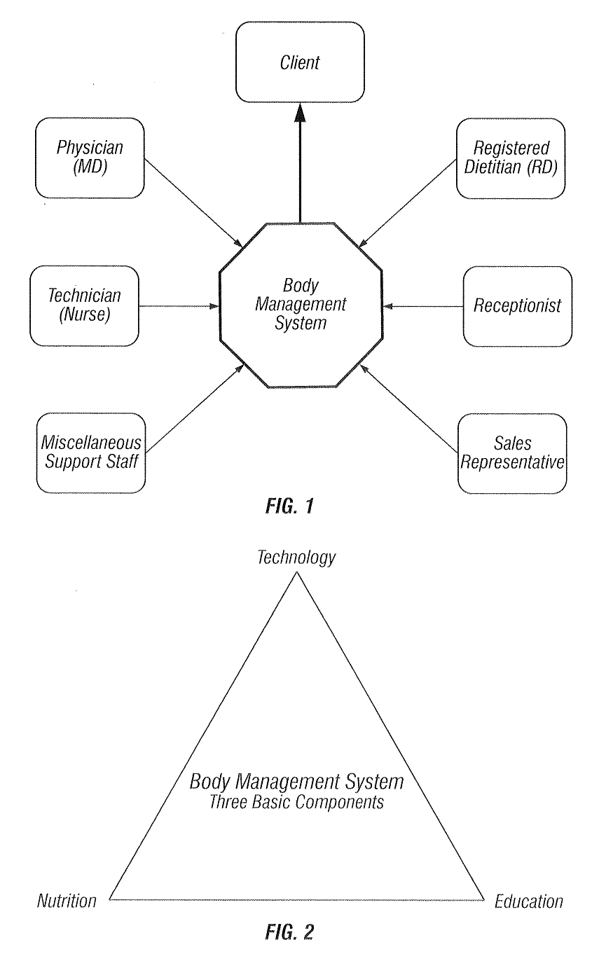

FIG. 1 provides a diagram showing the interrelationship of the various members of an embodiment of the present invention. This embodiment of the Body Management System (BMS) employs at least one MD, RD, Technician (possibly a Nurse), receptionist, sales representative, and miscellaneous support staff. While the job positions are distinct, it is possible for more than one position to be fulfilled by the same individual with the requisite credentials. These five members work together to form the core of the BMS. Ultimately, it is the client that receives the benefits of the BMS.

FIG. 2 shows the three basic components of the present embodiment of the BMS. Technology, education, nutrition and medical management are combined in a novel fashion to allow the BMS client to achieve his or her goals in body shaping and long term management. The technology utilized includes health assessment equipment and specialized medical and fitness machines. Education is provided to the client from the various health professionals (MD, RD, nurse) involved in the treatments. Finally, nutrition is addressed through the specialized nutrition plans and meal choices that arise during the nutrition education and training. By focusing on these three components, the client's goals can be readily attained.

### BMS Process

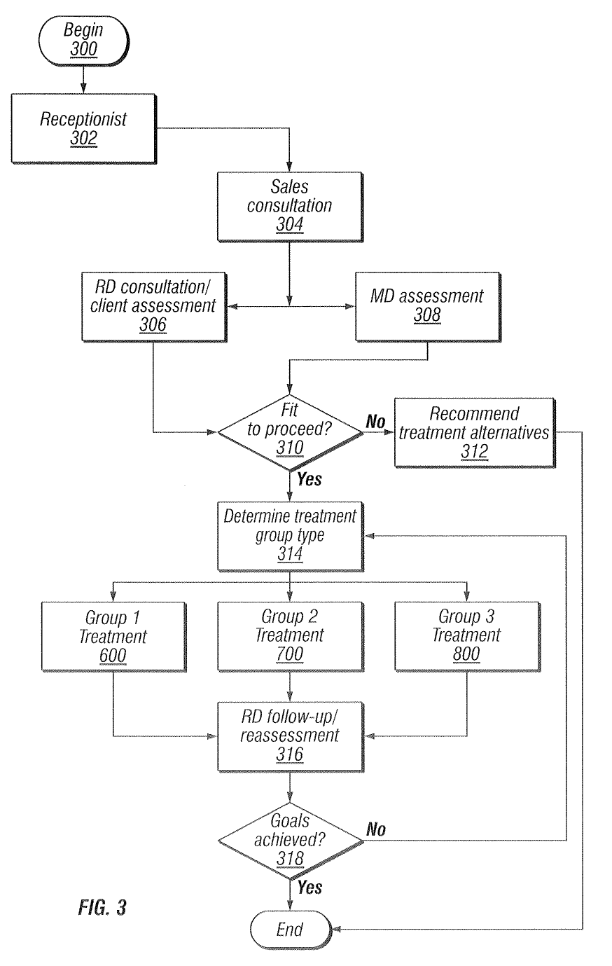

FIG. 3 represents a flow diagram of the steps taken 300 in this embodiment of the BMS. The first step is for the prospective client to meet with the receptionist 302. The receptionist is vital in that he or she is typically the client's first contact and will be the one who schedules the initial processing. In this first meeting with the receptionist 302 (either by phone, E-mail, or walk-in), the prospective client is scheduled with a sales representative.

The sales consultant 304 meets with the prospective client and conducts a tour of the BMS facility. After the tour, the client receives a slide presentation explaining the BMS process and equipment. During the presentation the consultant describes the costs associated with the treatments as well as the available payment plans. Available BMS supplied nutritional supplements are also discussed and a brief meeting with the RD is conducted. The RD briefly describes the BMS process from the RD's viewpoint and answers any questions. Finally, the client is returned to the receptionist with a signed contract and first payment. The receptionist schedules an extended RD meeting with the client.

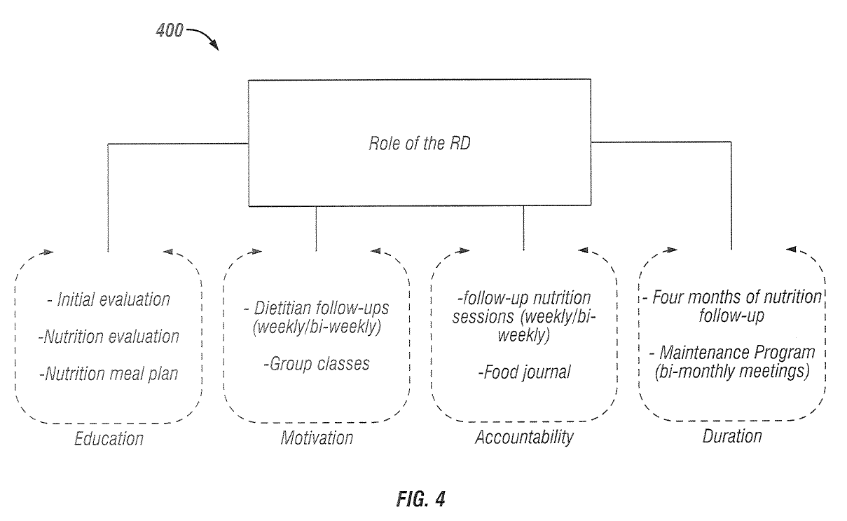

The client meets with the RD for an extensive RD assessment 306. FIG. 4 is a diagram highlighting the role of the RD 400. There are essentially four portions that define the RD's role (1) education; (2) motivation; (3) accountability; and (4) duration. Education occurs primarily during the initial assessment phase wherein an initial assessment is conducted and a nutrition evaluation and nutrition meal plan are introduced. Motivation, accountability, and duration come into play during the subsequent treatment phase.

Referring again to FIG. 3, the RD first weighs the client, measures the client's waist, and takes photographs to capture the client's initial condition for later comparisons during treatment. Photographs in the present embodiment are taken using medical grade photography equipment with a scaled backdrop for precise determination of body dimensions. However, one skilled in the art will appreciate that photographs may be taken using any type of camera with a consistent backdrop. Ideally, the photos should be taken with similar lighting and at the same distance from the subject.

Following the photograph, the RD obtains the client's body fat percentage, hydration levels, basal metabolic rate, and body mass index (BMI). In the present embodiment, a Tanita® BC-418 scale is used which makes these determinations through bioelectrical impedance analysis (BIA). FIG. 14 shows a drawing of such a machine 1400. However, other BIA equipment and methods may be used to obtain the same measurements.

Next, the RD provides the client with a tote bag containing a folder, sandals, a heart rate monitor (HRM), a pedometer and some nutritional reference charts (“slide guides”). The client is given the option of purchasing the HRM and is instructed on proper operation of the HRM and pedometer and subsequently encouraged to use them while exercising. By receiving a pedometer, it is expected that a client will feel more encouraged to walk, which is one of the most beneficial exercises one can do.

The RD discusses nutrition and dietary concerns with the client. From the data obtained during the assessment, the RD:
Provides the patient with their “Perfect Point” and their “current Point”. The point is the result of a calculation that takes into account the patient's fat percentage, the total daily caloric expenditure of the patient (RMR, exercise, daily activity and FP technology component) and the daily caloric intake of the patient as determined by the RD. Other values may be imputed depending on the shape of the patient such as, but not limited to, waist to hips ratio, waist to height ratio and waist circumference. The “Perfect Point” is intended to give the patient clear visibility as to his/her progression towards his/her goal.
Computes an adjusted daily caloric requirement for the client and customizes a menu plan that will provide it. The RD instructs the client on proper portion sizes and utilizes food models to demonstrate what a properly portioned meal looks like. To encourage and reinforce proper eating habits, a food log is provided for the client to keep accurate logs on what is consumed.

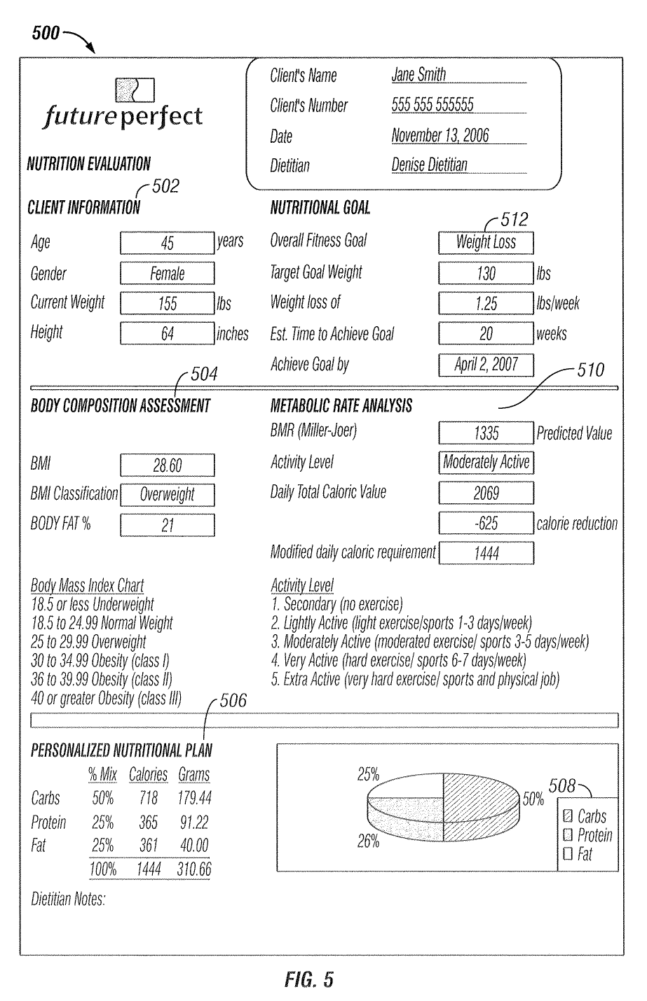

FIG. 5 illustrates a nutrition evaluation 500 as would be generated by the RD during the initial client assessment. This evaluation includes the client information 502 (i.e., age, gender, height, and weight); the client's nutritional goal 512 (i.e., overall fitness goal, target weight goal, and time to achieve); the client's body composition 504 (i.e., BMI, classification, body fat percentage); the client's metabolic rate (i.e., BMR, activity level, daily caloric values); and a personalized nutritional plan 506 that breaks down the caloric requirement into carbohydrates, proteins, and fats. Also included is a visual graph 508 representative of the nutritional plan 506.

A nutrition meal plan is developed by the RD to teach the client how to eat for the rest of his or her life. It is a plan based on the client's caloric needs and incorporates both the American Diabetic Association and the American Dietetic Association guidelines. Each of the different food groups (i.e., starch, fruit, protein, etc.) are provided for variety. In conjunction with the meal plan, the RD utilizes food models as a visual aid to educate the client on balance and portion control. Clients are also instructed on how to interpret food labels and how to make proper meal choices based on restaurant menu information.

If the client is not sufficiently physically fit to proceed, the MD and/or RD may consult with the client to recommend alternatives to the BMS 312. Recommendations may include a simplified exercise and weight loss plan that will enable the client to achieve the requisite fitness to proceed with the BMS treatments. If, however, the client is deemed fit enough to proceed with treatment then the client assessments are used to qualify him or her for a particular treatment group 314.

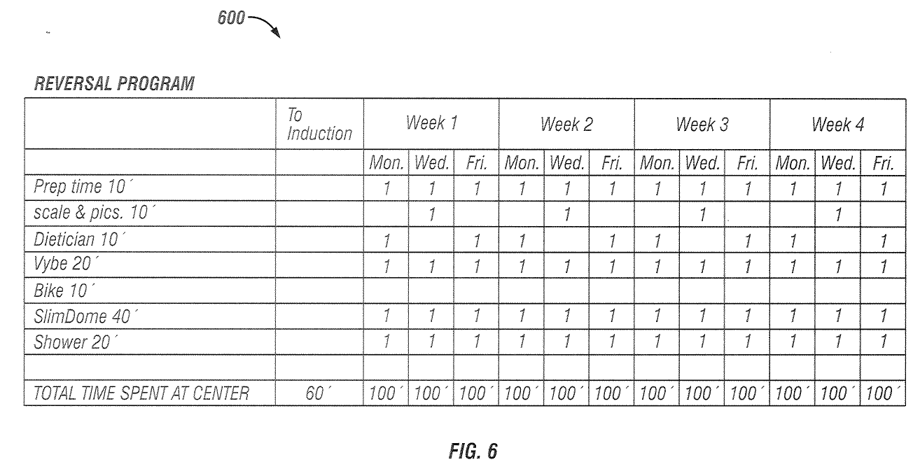

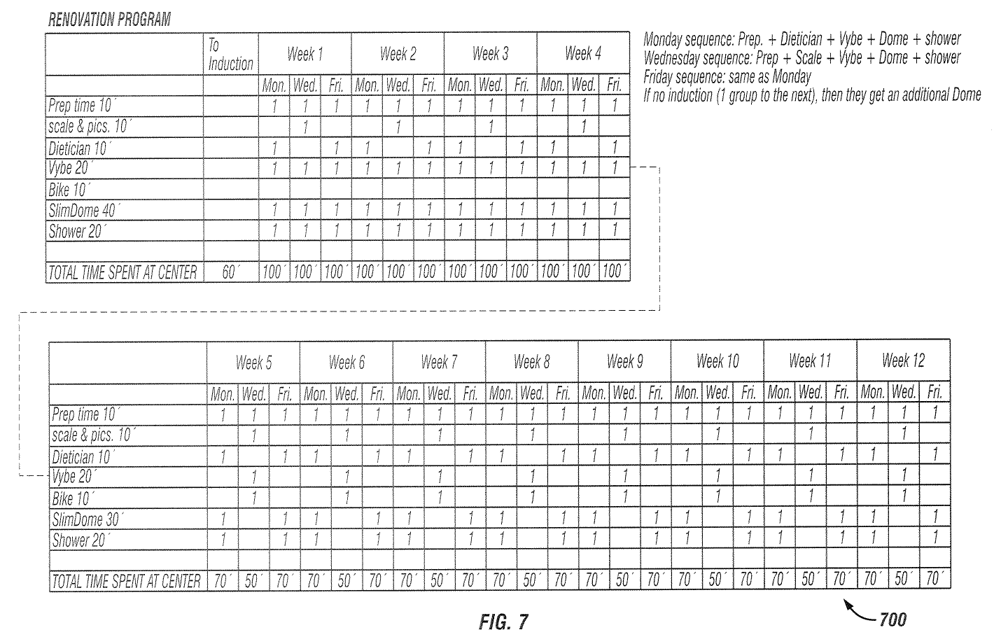

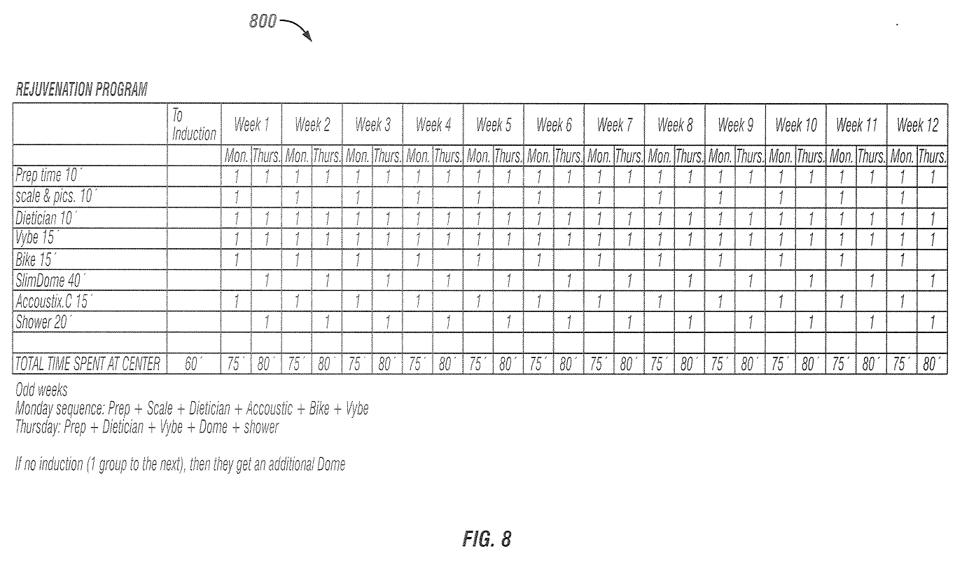

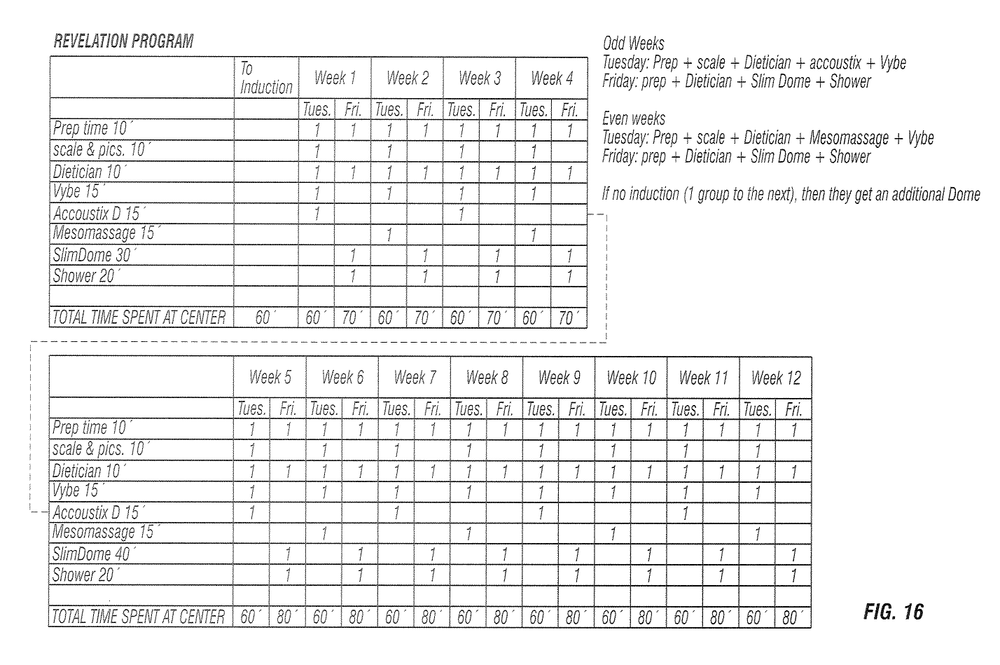

In the present embodiment, there are three different treatment groups. Group 1 treatment (“Reversal program”) applies if the client is found to be more than 45 pounds overweight (FIG. 6). Group 2 treatment (“Renovation program”) applies if the client is found to be 30-45 pounds overweight (FIG. 7). Group 3 treatment (Rejuvenation program) applies if the client is 15-35 pounds overweight (FIG. 8). Finally, Group 4 treatment (Revelation program) applies if the client is 0-15 pounds overweight (FIG. 16).

FIG. 6 is a table showing the steps of the Group 1 treatment 600. Because this group is the most overweight, the treatment is designed to ensure steady BMI improvement through fat loss, muscle build-up, and skin toning & firming.

Within this table, each column is represented by the number of days since the beginning of treatment. The rows provide the activities of the treatment. A numeral in any cell of the table indicates that the particular step is practiced for the given number of iterations on the particular day. For example, on day 1 of the treatment the client prepares for the activities (“Prep. Time”—10 minutes); gets weighed and photographed (“Scale+pics”—10 minutes); meets with the dietitian (“Dietitian”—10 minutes); utilizes the FitVibe® machine (“FitVibe”) or Vybe™ machine (“Vybe”) for 10 minutes; utilizes the SLIMDome machine (“Dome”) for 30 minutes; and showers and dresses (“Shower+dress”—20 minutes). Each day's treatments for this group are designed to take no more than 90 minutes to complete. On subsequent days, certain activities are left off while others are increased or added (“Bike”—10 minutes) yet the total treatment time remains at 90 minutes.

FIG. 7 is a table showing the steps of Group 2 treatment 700. Because this treatment is for patients that are 30-45 pounds overweight, its focus is on sculpting localized areas of the patients' body. For example, on day 1 of the treatment the patients prepares for the activities (“Prep. Time”—10 minutes); gets weighed and photographed (“Scale+pics”—10 minutes); utilizes the SLIMDome machine (“Dome”) for 30 minutes; and showers and dresses (“Shower+dress”—20 minutes). Each day's treatments for this group are designed to take no more than 70 minutes to complete. On subsequent days, the types of activities change but the treatment time remains at 70 minutes. On day 4, for instance, the “Dome” is replaced by 15 minutes on the “FitVibe” or “Vybe” and 15 minutes on the Bike. Also, the “Cellactor” and “Dietitian” are added in place of the “Scale+pics” and “Shower+dress.”

FIG. 8 is a table showing the steps of Group 3 treatment 800. This treatment is for patients that are 15-35 pounds overweight. Consequently, the overall focus is on improvement in appearance of cellulite. For example, on day 1 of the treatment consists of 10 minutes of “Prep. Time”; 10 minutes of “Dietitian” time; 15 minutes of “D-Actor” or “Acoustix D” time; 15 minutes of “FitVibe” or “Vybe” time; 15 minutes of “Bike” time; and 10 minutes of time to shower and dress. Each treatment is designed to take no more than 70 minutes for this group as well. The sequence changes on day 4 of the treatment while still remaining at 70 minutes. On day 4, the patient spends 10 minutes preparing; 10 minutes being weighed and photographed; 15 minutes with the “D-Actor;” 25 minutes undergoing “Electrophoresis;” and 10 minutes to shower and dress.

FIG. 16 is a table showing the steps of Group 4 treatment. This treatment is for patients that are 0-15 pounds overweight. Consequently, the overall focus is on firmness and tone of skin and muscle as well as an overall healthy appearance. For example, the treatment is split into even and odd weeks, with two treatments each week. On the first week and subsequent odd weeks, the first treatment day consists of “Prep” for 10 minutes; “scale & pics” for 10 minutes; “Dietitian” consult for 10 minutes; “Accoustix D” or “D-Actor” for 15 minutes; and “Vybe” for 15 minutes. The next treatment day would involve “Prep” for 10 minutes; “Dietitian” consult for 10 minutes; “SLIMDome” for 30 minutes; and “Shower” for 20 minutes. On the even weeks, the first treatment day consists of “Prep” for 10 minutes; “Scale & pics” for 10 minutes; “Dietitian” consult for 10 minutes; “Mesomassage” treatment for 15 minutes; and “Vybe” for 15 minutes. The second treatment day on the even weeks consists of “Prep” for 10 minutes; “Dietitian” consult for 10 minutes; “SLIMDome” for 30 minutes; and “Shower” for 20 minutes.

### Means for Burning Fat

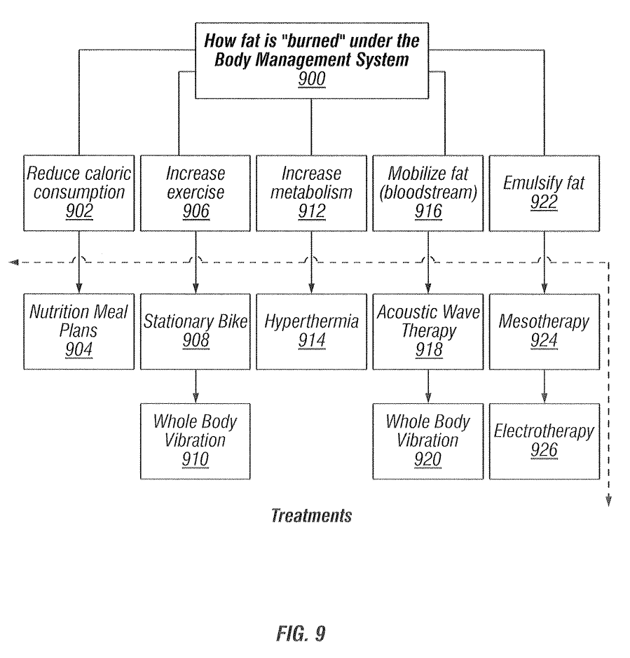

FIG. 9 shows a diagram of the means utilized by the present embodiment to “burn” the client's fat during treatments 900. Fat is “burned” by reducing caloric consumption 902; increasing exercise 906; increasing metabolism 912; mobilizing fat in the bloodstream 916; and emulsifying the fat cells 922. Each of these means comprise specific treatments. For example, reducing caloric consumption 902, as mentioned previously, is handled primarily with nutritional meal plans 904 as directed by the RD. Technology is applied to the remaining components to effectuate them.

### Increase Exercise

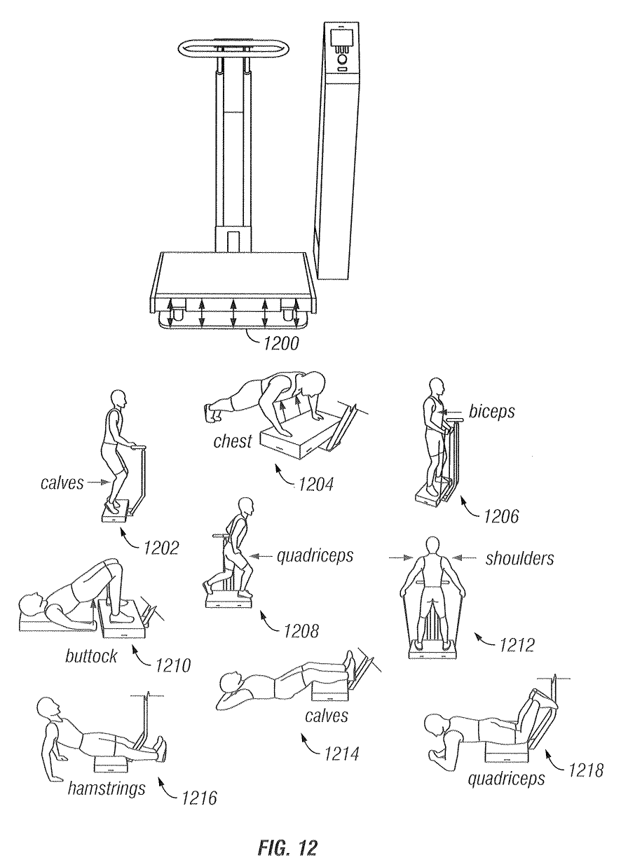

To increase exercise 906, the present embodiment employs a stationary bike 908 and whole body vibration 910 (WBV). Whole body vibration 910 utilizes a vibratory platform upon which the client can conduct various exercises. For example, FIG. 12 shows a commercial device known as the FitVibe® 1200. Upon this device the client can work calves 1202; chest 1204; biceps 1206; quadriceps 1208; buttock 1210; shoulders 1212; calves lying down 1214; hamstrings 1216; and quadriceps lying down 1218. The type of exercise performed on the whole body vibration platform depends upon the client's abilities and the RD's recommendations. While the present embodiment utilizes a FitVibe® device, other whole body vibration platforms, such as the Vybe™ can be utilized without straying from the scope of the invention.

### Increase Metabolism

To increase metabolism 912, the present embodiment utilizes whole body hyperthermia 914. Hyperthermia serves to raise the body temperature, causing a corresponding increase in heart rate; vasodilation; increased cellular exchanges; and deep tissue sudation (sweat from the sebaceous glands). The increased heart rate and vasodilation result in increased blood flow to the skin. This increased blood flow provides more oxygen to the skin tissue and accelerates removal of waste byproducts. Overall, the skin tone and texture is improved as well as a result of the increased temperature. Increasing cellular exchanges accelerates mitochondrial activity and boosts the immune system. This improves overall health and is useful in preventing and stopping disease progression. Sebaceous gland sweating results in sebaceous oil being excreted, leading to weight loss and is beneficial in that it detoxifies the body through the removal of heavy metals and toxins (i.e., dioxins, mercury, lead, etc.).

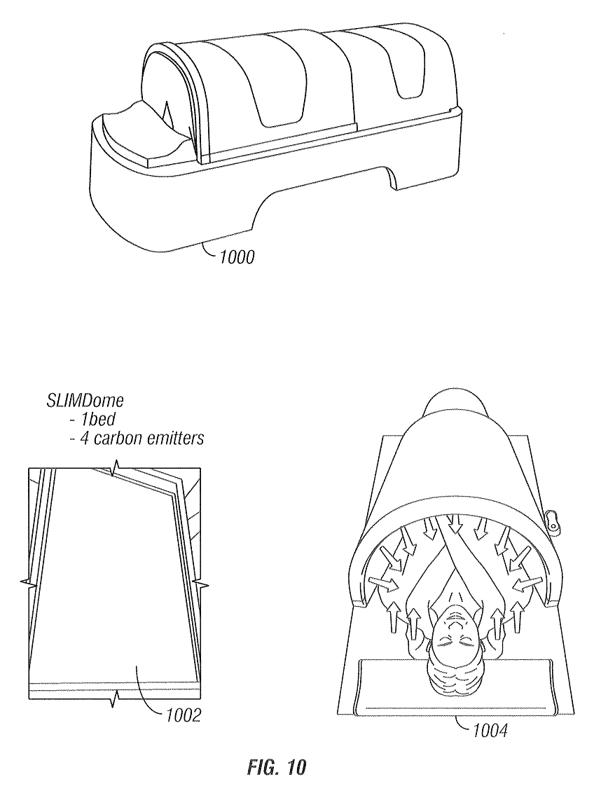

As shown in FIG. 10, the present embodiment employs a SLIMDome™ appliance 1000 which comprises a bed within a chamber. A client lies on the bed within the chamber 1004. Carbon heaters within the chamber 1002 emit energy in the far infrared spectrum so that heat penetration in the skin is approximately 5 mm. One skilled in the art will appreciate that other whole body hyperthermia treatment devices can be employed and are within the scope of the present invention.

### Mobilize Fat

To mobilize fat in the bloodstream 916, the present embodiment utilizes acoustic wave therapy 918 and whole body vibration 920. Acoustic Wave Therapy (AWT) involves passing shock waves through the skin to the underlying fat cells. If the fat cells can be compressed sufficiently, triglycerides from the fat cells can leak into the interstitial space between the cells and eventually pass into the bloodstream. In the bloodstream the triglycerides break down into free fatty acids which can be readily metabolized. This, when immediately followed with exercise using either WBV or the bike, results in localized fat reduction and reduced body circumference.

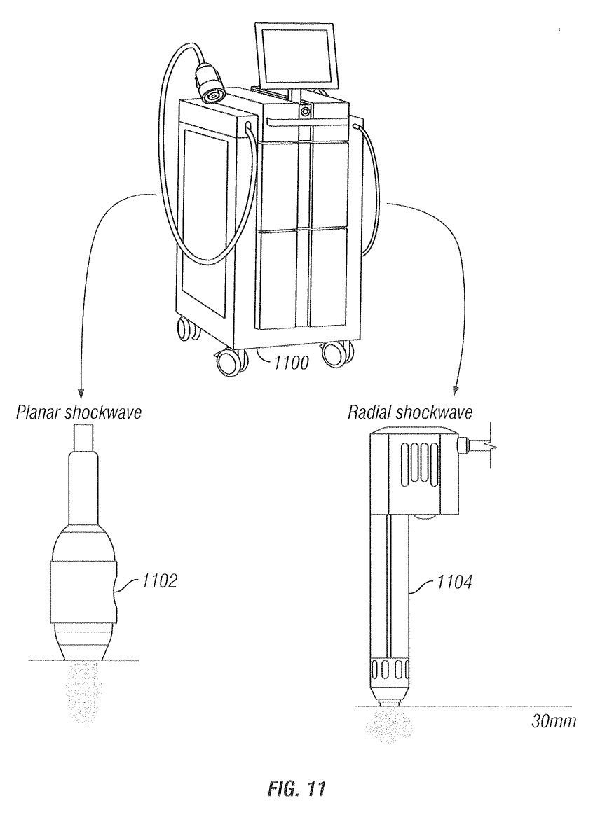

As shown in FIG. 11, the present embodiment employs a Cellactor® dermatological shock wave therapy device 1100 in Group 2 Treatment 700 which generates both planar shock waves 1102 and radial shock waves 1104. Planar shock waves 1102 are generated electromagnetically and provide a compressive effect for forcing the triglycerides from the deep fat cells. Radial shock waves 1104 are ballistic and tend to provide a vibratory effect that is more superficial for dealing primarily with cellulite. Group 3 Treatment 800 employs the D-Actor® for generating acoustic wave pulses. The D-Actor® functions similarly to the Cellactor® but acts more superficially to deal with cellulite in clients that are not as overweight. While the present invention employs a Cellactor® or D-Actor®, other AWT devices, such as the “Accoustix D®, can be utilized without straying from the inventive concept.

Whole body vibration 920 is utilized to improve muscle, bone, and joint strength as well as improve circulatory and nervous system functioning. With the vibratory platform mentioned previously, it is possible for the client to perform exercises while receiving the vibratory treatment. FIG. 12 shows various exercises that can be performed on the platform (1202 to 1218). By exercising while undergoing WBV, more muscle groups are employed due to the body compensating for the additional movement. Also, joints are stimulated as joint fluid is moved through the cartilage by the intermittent pressure. These vibrations stimulate and strengthen the cartilage as well as the tendons and other connective tissues. WBV has also been shown to increase testosterone and HGH levels in the body which further improves bone density and improves the circulatory system overall. As mentioned previously, the present embodiment utilizes the FitVibe® WBV. However, any WBV device may be utilized and is within the scope of the present invention.

### Emulsify Fat

To emulsify fat 922, the present embodiment employs mesotherapy 924 and electrotherapy 926. Mesotherapy 924 is a process that involves the injection of small doses of medications into the hypodermis. The present embodiment utilizes a mixture comprising phosphatidylcholine, deoxycholate, L-carnatine, Yohimbine, caffeine, amynophilline, lidocaine, hyaluronidase, mellolitus and arnica. Because multiple injections are required, mesotherapy 924 is only used to target small, isolated areas of the client's skin.

Electrotherapy 926 involves the application of electrical current or high frequency sound waveforms to open pathways into the skin thereby permitting the large Mesotherapy molecules to penetrate through the skin and produce their effect on fat. Ultrasound uses high frequency sound waves that create macrovacuoles between the cells, thus further assisting Electrotherapy in maximizing Mesotherapy product penetration through the skin to the fat cells.

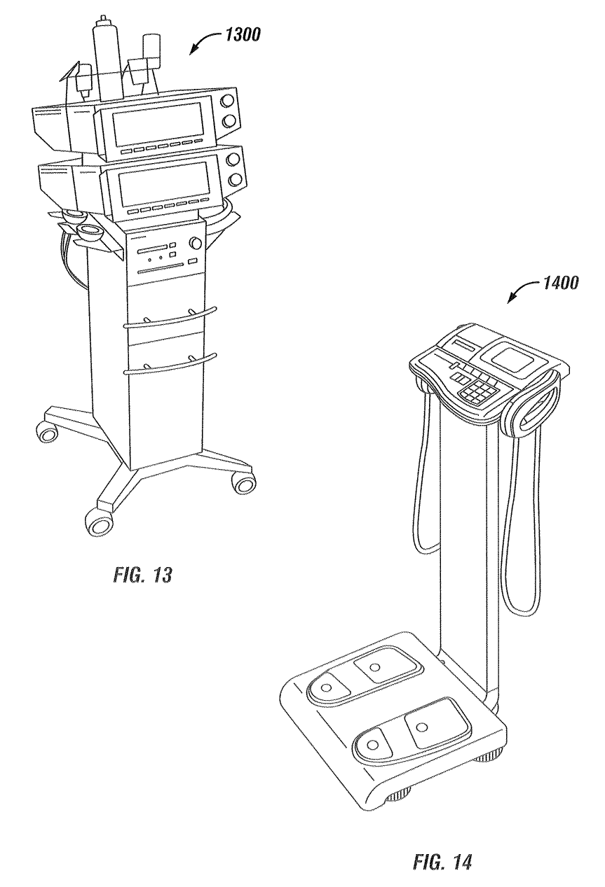

As shown in FIG. 13, the present embodiment utilizes the Zimmer® Galva™ 5 and Sono™ 5 devices 1300 to conduct electrotherapy 926 and ultrasound therapy 928 respectively. The Galva™ device generates a either a DC or alternating current, continuous or pulsed, waveform to open pathways into the skin. The Sono™ device generates ultrasound waveforms to assist the Galva device in maximizing product penetration. One skilled in the arts will appreciate that other devices may be chosen to conduct electrotherapy without straying from the scope of the present invention.

### Reassessment/Follow-Up

Referring again to FIG. 3, the RD then conducts weekly or bi-weekly follow-ups with the client 316 during treatments. During these follow-ups, the RD reassesses the client's present condition and compares it with the client's stated goals. Adjustments are made to the nutrition meal plan and the treatment plan is changed if the client has moved into a different category 314.

Once the client's goals have been reached 318, the BMS treatments are halted. At this point, the client should possess the knowledge and motivation necessary to maintain their body on their own. To assist the client, he or she is encouraged to maintain a food journal and conduct follow-up nutrition sessions with the RD.

Also, the client can attend bi-monthly meetings as a maintenance program to ensure their knowledge and motivation are retained. The maintenance program features twice monthly visits with the RD and unlimited access to weekly nutrition education classes. Access to technology (i.e., WBV, hyperthemia, AWT, etc.) is limited to 2 sessions per month and is determined by the technician based on requirements and the goals of the client.

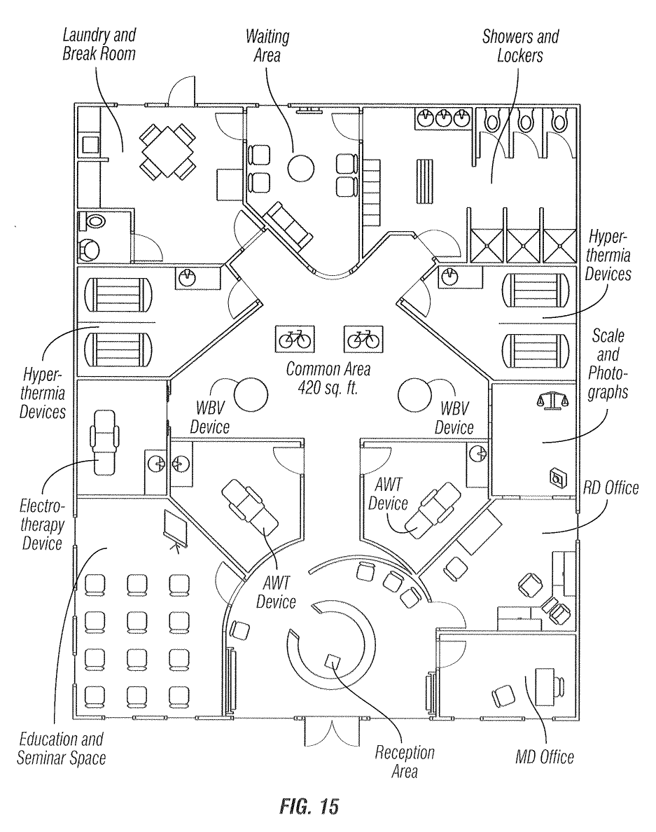

FIG. 15 shows a treatment office floor plan of a preferred embodiment of the present invention. The layout of the treatment rooms and equipment has been chosen to provide optimal use of the available spaces.

It will now be evident to those skilled in the art that there has been described herein an improved whole body management system and method. Although the invention hereof has been described by way of a preferred embodiment, it will be evident that other adaptations and modifications can be employed without departing from the spirit and scope thereof. For example, a different device can be substituted for the hyperthemia treatments so long as it achieves the same results through whole body heating as specified previously. Or, for example, some of the steps in the system procedure could be conducted out of order yet still achieve the same end result.

The terms and expressions employed herein have been used as terms of description and not of limitation; and thus, there is no intent of excluding equivalents, but on the contrary it is intended to cover any and all equivalents that may be employed without departing from the spirit and scope of the invention.

We claim:

1. A system for managing the weight loss and body shaping of a client, the system comprising:
a medical doctor (“MD”);
a registered dietitian (“RD”);
at least one exercise device;
at least one hyperthermia treatment device;
at least one Acoustic Wave Therapy device;
at least one whole body vibration device;
at least one mesotherapy device; and
at least one electrotherapy device.

2. The system of claim 1 wherein the clientele's gender is exclusive.

3. The system of claim 1 wherein the at least one exercise device is chosen from the group consisting of a stationary bike, a rowing machine, a stair climbing machine, and a whole body vibration device.

4. The system of claim 1 wherein the at least one hyperthemia treatment device is sized to treat the client's entire body.

5. The system of claim 1 wherein the at least one acoustic wave therapy device operates using pneumatically generated pulses and electromagnetically generated pulses.

6. The system of claim 1 wherein the at least one whole body vibration device is a vibration platform, wherein the client performs exercises while standing on the platform, and wherein the platform mechanically vibrates the client's entire body.

7. The system of claim 1 wherein the at least one mesotherapy device utilizes a mixture of compounds chosen from the group consisting of phosphatidylcholine, deoxycholate, L-carnatine, Yohimbine, caffeine, amynophilline, lidocaine, hyaluronidase, mellolitus and arnica.

8. The system of claim 1 wherein the electrotherapy device generates either an AC or DC continuous or pulsed waveform for treating the client.

9. A method for managing the weight loss and body shaping of a client, the method involving an MD, an RD, and a nurse, the method comprising the following steps:
(a) conducting an RD assessment of the client;
(b) reviewing the RD assessments to determine client fitness and to determine a treatment group type based on the client's weight;
(c) determining the client's “Perfect Point” and “Current Point”;
(d) treating the client in accordance with the client's treatment group type;
(e) conducting an RD reassessment to determine if goals have been achieved or if the client should have a different treatment group type; and
(f) repeating steps (d) through (e) until the client's goals have been achieved.

10. The method of claim 9 wherein the treatment group type is Group 1, the method further comprising the following steps:
(d)(1) preparing for the treatment;
(d)(2) using a hyperthermia treatment device;
(d)(3) using a whole body vibration device;
(d)(4) using an exercise device;
(d)(5) obtaining the client's current weight measurement and client's current photograph;
(d)(6) consulting with the RD to assess nutrition and treatment progress; and
(d)(7) showering and dressing.

11. The method of claim 10 wherein steps (d)(1) through (d)(7) are performed in a sequence timed to take no more than approximately 100 minutes total to complete

12. The method of claim 9 wherein the treatment group type is Group 1, the method further comprising the following steps:
(d)(1) preparing for the treatment for approximately 10 minutes, wherein this step is performed at least once each treatment day;
(d)(2) using a hyperthermia treatment device for approximately 40 minutes, wherein this step is performed at least once each treatment day;
(d)(3) using a whole body vibration device for approximately 20 minutes, wherein this step is performed at least once each treatment day;
(d)(4) using an exercise device for approximately 10 minutes, wherein this step is performed as time permits;
(d)(5) obtaining the client's current weight measurement and client's current photograph in at most 10 minutes, wherein this step is performed at least once each treatment week;
(d)(6) consulting with the RD to assess nutrition and treatment progress for approximately 10 minutes, wherein this step is performed at least twice each treatment week; and
(d)(7) showering and dressing in at most 20 minutes, wherein this step is performed each treatment day.

13. The method of claim 9 wherein the treatment group type is Group 2, the method further comprising the following steps:
(d)(1) preparing for the treatment;
(d)(2) using a hyperthermia treatment device;
(d)(3) using a whole body vibration device;
(d)(4) using an exercise device;
(d)(5) obtaining the client's current weight measurement and client's current photograph;
(d)(6) consulting with the RD to assess nutrition and treatment progress; and
(d)(7) showering and dressing.

14. The method of claim 13 wherein steps (d)(1) through (d)(7) are performed in a sequence timed to take no more than approximately 100 minutes total to complete.

15. The method of claim 9 wherein the treatment group type is Group 2, the method further comprising:
(d)(1) preparing for the treatment for approximately 10 minutes, wherein this step is performed at least once each treatment day;
(d)(2) using a hyperthermia treatment device for approximately 40 minutes, wherein this step is performed at least once each treatment day;
(d)(3) using a whole body vibration device for approximately 20 minutes, wherein this step is performed at least once each treatment day;
(d)(4) using an exercise device for approximately 10 minutes, wherein this step is performed as time permits;
(d)(5) obtaining the client's current weight measurement and client's current photograph in at most 10 minutes, wherein this step is performed at least once each treatment week;
(d)(6) consulting with the RD to assess nutrition and treatment progress for approximately 10 minutes, wherein this step is performed at least twice each treatment week; and
(d)(7) showering and dressing in at most 20 minutes, wherein this step is performed at least once each treatment day.

16. The method of claim 9 wherein the treatment group type is Group 3, the method further comprising the following steps:
(d)(1) preparing for the treatment;
(d)(2) using a hyperthermia treatment device;
(d)(3) using a whole body vibration device;
(d)(4) using an exercise device;
(d)(5) using an acoustic wave therapy device;
(d)(6) obtaining the client's current weight measurement and client's current photograph;
(d)(7) consulting with the RD to assess nutrition and treatment progress; and
(d)(8) showering and dressing.

17. The method of claim 16 wherein the steps (d)(1) through (d)(8) are performed in a sequence timed to take approximately 75 to 80 minutes total to complete.

18. The method of claim 9 wherein the treatment group type is Group 3, the method further comprising the following steps:
(d)(1) preparing for the treatment for approximately 10 minutes, wherein this step is performed at least once each treatment day;
(d)(2) using a hyperthermia treatment device for approximately 40 minutes, wherein this step is performed at least once each treatment day;
(d)(3) using a whole body vibration device for approximately 15 minutes, wherein this step is performed at least once each treatment day;
(d)(4) using an exercise device for approximately 15 minutes, wherein this step is performed at least once each treatment day;
(d)(5) using an acoustic wave therapy device for approximately 15 minutes, wherein this step is performed at least once each treatment week;
(d)(6) obtaining the client's current weight measurement and client's current photograph in at most 10 minutes, wherein this step is performed at least once each treatment week;
(d)(7) consulting with the RD to assess nutrition and treatment progress for approximately 10 minutes, wherein this step is performed at least once each treatment day; and
(d)(8) showering and dressing in at most 20 minutes, wherein this step is performed at least once each treatment week.

19. The method of claim 9 wherein the treatment group type is Group 4, the method further comprising:
(d)(1) preparing for the treatment;
(d)(2) using a whole body vibration device;
(d)(3) using an acoustic wave therapy device;
(d)(4) using a mesotherapy device;
(d)(5) using a hyperthermia treatment device;
(d)(6) obtaining the client's current weight measurement and client's current photograph;
(d)(7) consulting with the RD to assess nutrition and treatment progress; and
(d)(8) showering and dressing.

20. The method of claim 19 wherein the steps (d)(1) through (d)(8) are performed in a sequence timed to take no more than approximately 60 to 70 minutes total to complete.

21. The method of claim 9 wherein the treatment group type is Group 4, the method further comprising:
(d)(1) preparing for the treatment for approximately 10 minutes, wherein this step is performed at least once each treatment day;
(d)(2) using a whole body vibration device for approximately 15 minutes, wherein this step is performed at least once each treatment week;
(d)(3) using an acoustic wave therapy device for approximately 15 minutes, wherein this step is performed at least once every other treatment week;
(d)(4) using a mesotherapy device for approximately 15 minutes, wherein this step is performed at least once every other treatment week;
(d)(5) using a hyperthermia treatment device for approximately 30 minutes, wherein this step is performed at least once each treatment week;
(d)(6) obtaining the client's current weight measurement and client's current photograph in at most 10 minutes, wherein this step is performed at least once each treatment week;
(d)(7) consulting with the RD to assess nutrition and treatment progress for approximately 10 minutes, wherein this step is performed at least once each treatment day; and
(d)(8) showering and dressing in at most 10 minutes, wherein this step is performed at least once each treatment week.
